(19) United States
(12) Patent Application Publication
(10) Pub. No.: US 2020/0389724 A1
(43) Pub. Date: Dec. 10, 2020

(54) STORAGE MEDIUM, SPEAKER DIRECTION DETERMINATION METHOD, AND SPEAKER DIRECTION DETERMINATION APPARATUS

(71) Applicant: FUJITSU LIMITED, Kawasaki-shi (JP)

(72) Inventors: Akira Kamano, Kawasaki (JP); Yohei KISHI, Kawasaki (JP); Chisato Shioda, Sagamihara (JP); Masanao SUZUKI, Yokohama (JP)

(73) Assignee: FUJITSU LIMITED, Kawasaki-shi (JP)

(21) Appl. No.: 16/889,837

(22) Filed: Jun. 2, 2020

(30) Foreign Application Priority Data
Jun. 10, 2019 (JP) 2019-107707

(51) Int. Cl. H04R 1/40; H04R 1/22; H04R 5/04

(52) U.S. Cl. CPC H04R 1/406; H04R 5/04; H04R 1/222

(57) ABSTRACT

A speaker direction determination method includes acquiring a physical quantity indicating at least one of a phase difference and a sound pressure difference based on a plurality of sound signals acquired by the plurality of microphones; generating a correction model corrected such that the physical quantity in a correspondence in a reference model indicating the correspondence between a sound incidence angle onto the plurality of microphones in the case where the housing is located at the reference position and the physical quantity acquired in the case where the housing is located at the reference position corresponds to noise level indicated by the acquired noise information; setting the physical quantity corresponding to the sound incidence angle associated with the inclination indicated by the acquired inclination information in the correction model as a threshold; comparing the acquired physical quantity with the set threshold to determine a speaker direction.

### CROSS-REFERENCE TO RELATED APPLICATION

This application is based upon and claims the benefit of priority of the prior Japanese Patent Application No. 2019-107707, filed on Jun. 10, 2019, the entire contents of which are incorporated herein by reference.

### FIELD

The embodiments discussed herein are related to a storage medium storing a speaker direction determination program, a speaker direction determination method, and a speaker direction determination apparatus.

### BACKGROUND

An existing wearable voice translation system achieves voice translation in a hands-free manner by switching between a source language and a target language based on a speaker direction that is a direction in which a speaker is present. In the voice translation system, when the determination accuracy of the speaker direction is low, translation may not properly be performed and thus, it is demanded to further improve the determination accuracy of the speaker direction. Related art is disclosed in, for example, Japanese Laid-open Patent Publication No. 2018-40982.

### SUMMARY

According to an aspect of the embodiments, a non-transitory computer-readable storage medium storing a program that causes a computer to execute a process, the process includes acquiring inclination information indicating an inclination of a housing including a plurality of microphones with respect to a predetermined direction of a reference position; acquiring noise information on noise contained in at least one of a plurality of sound signals acquired by the plurality of microphones; acquiring a physical quantity indicating at least one of a phase difference and a sound pressure difference based on the plurality of sound signals acquired by the plurality of microphones; generating a correction model corrected such that the physical quantity in a correspondence in a reference model indicating the correspondence between a sound incidence angle onto the plurality of microphones in the case where the housing is located at the reference position and the physical quantity acquired in the case where the housing is located at the reference position corresponds to noise level indicated by the acquired noise information; setting the physical quantity corresponding to the sound incidence angle associated with the inclination indicated by the acquired inclination information in the correction model as a threshold; and comparing the acquired physical quantity with the set threshold to determine a speaker direction that is a direction in which a speaker making a speech corresponding to the plurality of sound signals acquired by the plurality of microphones is present.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a speaker direction determination apparatus in accordance with first to fourth embodiments;

FIG. 2 is a conceptual diagram illustrating a hardware configuration of the speaker direction determination apparatus in accordance with the first to fourth embodiments;

FIG. 3 is a block diagram illustrating a speaker direction determination unit in accordance with the first embodiment;

FIG. 4 is a conceptual diagram describing an inclination of a housing of the speaker direction determination apparatus with respect to a reference position;

FIG. 5A is a conceptual diagram describing a determination boundary of a speaker direction;

FIG. 5B is a conceptual diagram describing the determination boundary of the speaker direction;

FIG. 6 is a conceptual diagram illustrating a reference model;

FIG. 7 is a conceptual diagram illustrating correspondence between estimated phase difference and noise level;

FIG. 8 is a conceptual diagram illustrating correspondence between estimated phase difference and sound incidence angle;

FIG. 9 is a conceptual diagram illustrating a correction model;

FIG. 10 is a conceptual diagram illustrating the reference model and the correction model;

FIG. 11 is a block diagram illustrating a hardware configuration of the speaker direction determination unit;

FIG. 12 is a flowchart illustrating a flow of speaker direction determination processing in accordance with the first embodiment;

FIG. 13 is a block diagram illustrating a speaker direction determination unit in accordance with the second embodiment;

FIG. 14 is a block diagram illustrating a speaker direction determination unit in accordance with the third embodiment;

FIG. 15 is a flowchart illustrating a flow of speaker direction determination processing in accordance with the third embodiment;

FIG. 16 is a block diagram illustrating a speaker direction determination unit in accordance with the fourth embodiment;

FIG. 17 is a conceptual diagram illustrating the reference model and the correction model;

FIG. 18 is a flowchart illustrating a flow of speaker direction determination processing in accordance with the fourth embodiment;

FIG. 19 is a flowchart illustrating a flow of speaker direction determination processing in accordance with the fourth embodiment; and

FIG. 20 is a conceptual diagram illustrating a percentage of correct answers of the speaker direction determination processing.

### DESCRIPTION OF EMBODIMENTS

It is desired to properly determine a speaker direction.

### First Embodiment

An example of a first embodiment will be described below with reference to figures.

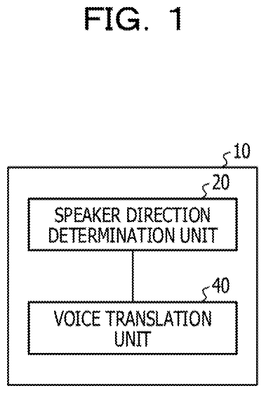

FIG. 1 is a functional block diagram illustrating a speaker direction determination apparatus 10. The speaker direction determination apparatus 10 includes a speaker direction determination unit 20 and a voice translation unit 40. The speaker direction determination unit 20 determines a speaker direction that is a direction in which a speaker is present. The voice translation unit 40 receives a determination result on the speaker direction from the speaker direction determination unit 20, and determines a source language and a target language based on the received determination result on the speaker direction to perform translation.

For example, the voice translation unit 40 translates a first language into a second language when the speaker direction is a forward direction of a housing of the speaker direction determination apparatus 10, and translates the second language into the first language when the speaker direction is an upward direction of the housing of the speaker direction determination apparatus 10. The first language may be English, for example, and the second language may be Japanese, for example.

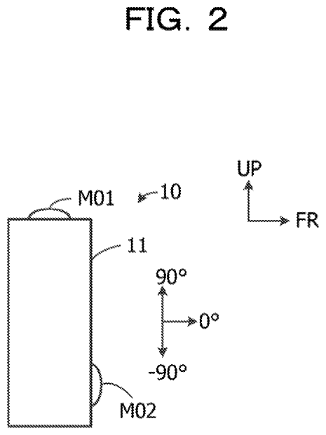

FIG. 2 illustrates a hardware configuration of the speaker direction determination apparatus 10. The speaker direction determination apparatus 10 includes a housing 11 shaped like a substantially rectangular parallelepiped, a first microphone (hereinafter first microphone may be referred to as first mic) M01 disposed on a surface that generally becomes an upper surface when a wearer wears the housing 11, and a second microphone (hereinafter second microphone may be referred to as second mic) M02 disposed on a surface that generally becomes a front surface when the wearer wears the housing 11. An arrow FR represents the forward direction when the wearer wears the housing 11, and an arrow UP represents the upward direction when the wearer wears the housing 11.

Angles 0 degree, 90 degrees, and −90 degrees are examples of sound incidence angle. For example, when the sound incidence angle is 90 degree or −90 degree, the incidence direction of sound is parallel to the front surface of the housing, and when the sound incidence angle is 0 degree, the incidence direction of sound is orthogonal to the front surface of the housing.

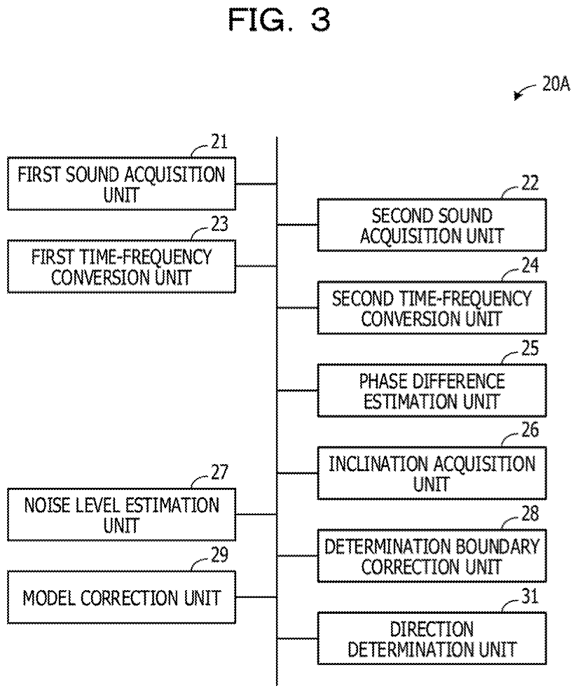

FIG. 3 illustrates a speaker direction determination unit 20A. The speaker direction determination unit 20A includes a first sound acquisition unit 21, a second sound acquisition unit 22, a first time-frequency conversion unit 23, a second time-frequency conversion unit 24, a phase difference estimation unit 25, an inclination acquisition unit 26, and a noise level estimation unit 27. The speaker direction determination unit 20A includes a determination boundary correction unit 28, a model correction unit 29, and a direction determination unit 31. The first sound acquisition unit 21 acquires a time-domain sound signal converted from sound detected by the first mic M01, and the second sound acquisition unit 22 acquires a time-domain sound signal converted from sound detected by the second mic M02.

The units included in the speaker direction determination unit 20A may be formed as individual hardware circuits configured by wired logic. The units included in speaker direction determination unit 20A may be implemented as one integrated circuit formed by integrating circuits corresponding to the units. The integrated circuit may be an integrated circuit such as an application-specific integrated circuit (ASIC), a field-programmable gate array (FPGA), or the like. The units in the speaker direction determination unit 20A each may be a functional module implemented by a computer program executed on a processor of the speaker direction determination unit 20A.

The first time-frequency conversion unit 23 converts the time-domain sound signal acquired by the first sound acquisition unit 21 into a frequency-domain sound signal. Conversion of the time-domain sound signal into the frequency-domain sound signal may be fast Fourier transformation (FFT), for example. The second time-frequency conversion unit 24 converts the time-domain sound signal acquired by the second sound acquisition unit 22 into a frequency-domain sound signal.

The phase difference estimation unit 25 that is an example of a physical quantity acquisition unit estimates a phase difference between the frequency-domain sound signal converted by the first time-frequency conversion unit 23 and the frequency-domain sound signal converted by the second time-frequency conversion unit 24. The phase difference that is an example of the physical quantity is a time difference in sound from a sound source to a microphone in the frequency domain, and an amplitude in the case where a sound signal is expressed as a complex number.

A phase difference dp(k) is estimated according to an equation (1), for example. dp(k) is a phase difference between a frequency-domain sound signal in a kth (k=0, 1, . . . , k−1) frequency band, which is converted by the first time-frequency conversion unit 23, and a frequency-domain sound signal in the kth frequency band, which is converted by the second time-frequency conversion unit 24. k may be 256, for example.

$$\begin{matrix}dp ( k ) = {θ}_{1} ( k ) - {θ}_{2} ( k ) \\ = arg ( {z}_{1} ( k ) ) - arg ( {z}_{2} ( k ) ) \\ = arg ( {z}_{1} ( k ) / {z}_{2} ( k ) )\end{matrix} \qquad ( 1 )$$

θ₁(k) is a phase spectrum of the sound signal in the kth frequency band, which is converted by the first time-frequency conversion unit 23, θ₂(k) is a phase spectrum of the sound signal in the kth frequency band, which is converted by the second time-frequency conversion unit 24, and are calculated according to a formula (2).

θ₁(k)=arg(z₁(k))=a tan(Im₁(k)/Re₁(k))

θ₂(k)=arg(z₂(k))=a tan(Im₂(k)/Re₂(k)) (2)

As expressed as a formula (3), z₁(k) is the frequency-domain sound signal in the kth frequency band, which is converted by the first time-frequency conversion unit 23, expressed as a complex number, Re₁(k) is a real part of the complex number, and Im₁(k) is an imaginary part of the complex number. z₂(k) is the frequency-domain sound signal in the kth frequency band, which is converted by the second time-frequency conversion unit 24, expressed as a complex number, Re₂(k) is a real part of the complex number, and Im₂(k) is an imaginary part of the complex number.

z₁(k)=Re₁(k)+i Im₁(k)

z₂(k)=Re₂(k)+i Im₂(k) (3)

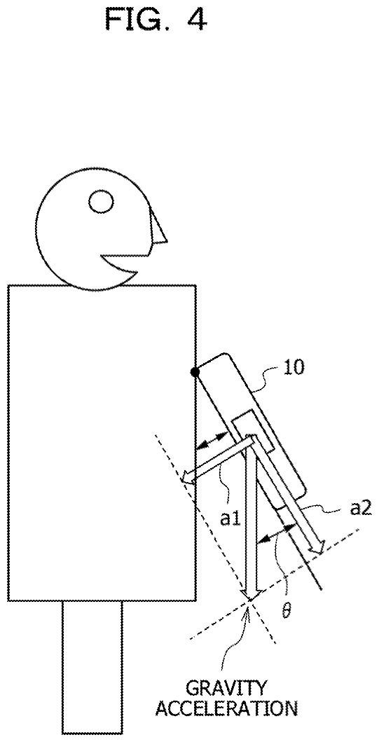

The inclination acquisition unit 26 that is an example of an inclination information acquisition unit acquires a value indicating an inclination with respect to a reference position of the housing 11 of the speaker direction determination apparatus 10 from an inclination detection sensor such as an acceleration sensor disposed in the housing 11 of the speaker direction determination apparatus 10. As illustrated in FIG. 4, when a longitudinal measurement acceleration of the speaker direction determination apparatus 10 is a₁, and a vertical measurement acceleration of the speaker direction determination apparatus 10 is a₂, an inclination with respect to the reference position of the speaker direction determination apparatus 10 is θ=tan⁻¹(a₁/a₂). It is assumed that the direction of the reference position is the direction of gravity acceleration.

The acceleration sensor is a two or more-axis sensor without DC components being cut. A gyro sensor or a magnetic field sensor may be used in place of the acceleration sensor. The inclination of the housing 11 of the speaker direction determination apparatus 10 when worn by the user, which varies according to the body shape of the user wearing the speaker direction determination apparatus 10, may be measured and recorded in advance.

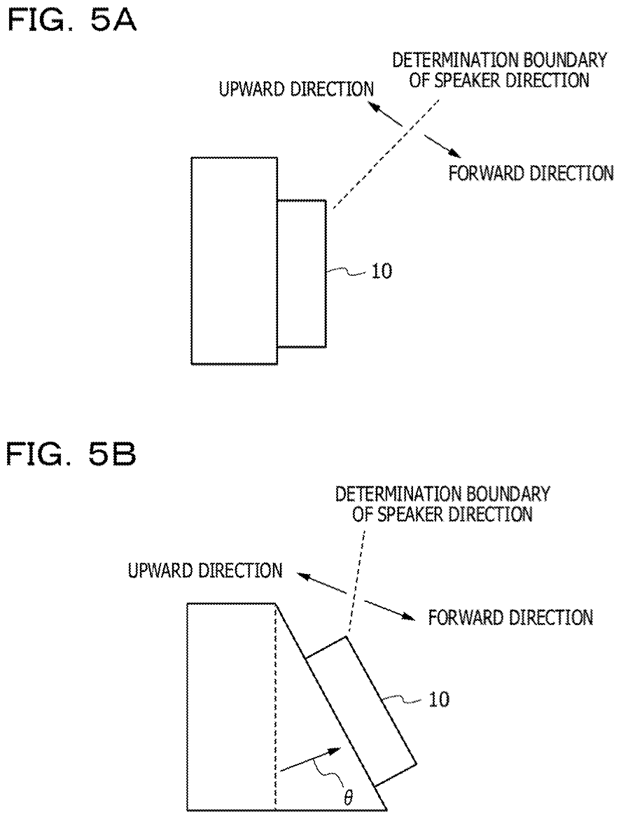

The determination boundary correction unit 28 corrects a speaker direction determination boundary that is an example of a threshold, based on the value indicating the inclination with respect to the reference position of the housing 11 of the speaker direction determination apparatus 10, which is acquired by the inclination acquisition unit 26. The speaker direction determination boundary varies with the case where the housing 11 of the speaker direction determination apparatus 10 is not inclined with the reference position as illustrated in FIG. 5A and the housing 11 of the speaker direction determination apparatus 10 is inclined with respect to the reference position as illustrated in FIG. 5B.

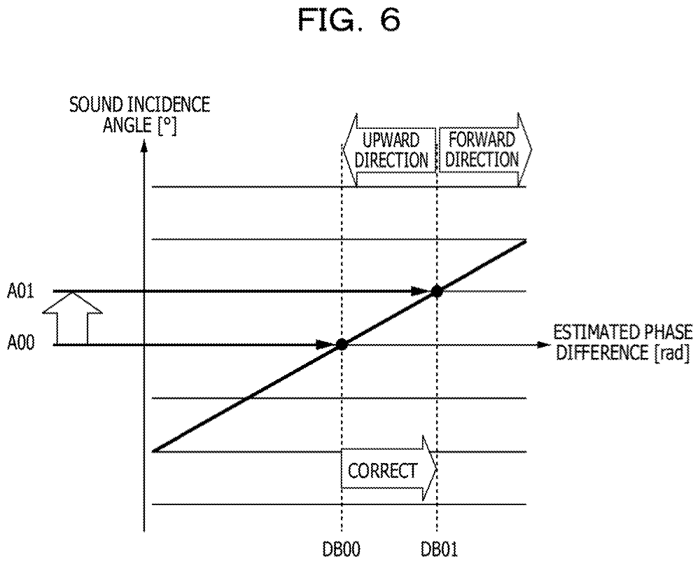

FIG. 6 illustrates a reference model used when the speaker direction is determined. The reference model indicates correspondence between the sound incidence angle onto a plurality of microphones in the state where the housing 11 is located at the reference position and an estimated phase difference acquired in the state where the housing 11 is located at the reference position. The estimated phase difference is an example of the physical quantity. In FIG. 6, a vertical axis represents the sound incidence angle [degree], and a horizontal axis represents the estimated phase difference [rad]. The reference model is a positively-inclined straight line indicating that the sound incidence angle is directly proportional to the estimated phase difference.

When the housing 11 is not inclined with respect to the reference position, the determination boundary is, for example, an estimated phase difference DB00 of the reference model in the case where the sound incidence angle is A00. When the estimated phase difference is equal to or smaller than DB00, the speaker direction is determined to be the upward direction. When the estimated phase difference is larger than DB00, the speaker direction is determined to be the forward direction.

When the housing 11 is inclined with respect to the reference position, the determination boundary is corrected to an estimated phase difference DB01 of the reference model at a sound incidence angle A01 corresponding to the inclination with respect to the reference position. When the estimated phase difference is equal to or smaller than DB01, the speaker direction is determined to be the upward direction, and when the estimated phase difference is larger than DB01, the speaker direction is determined to be the forward direction. As the inclination of the housing 11 with respect to the reference position becomes larger, the corrected determination boundary is further deviated from the uncorrected determination boundary.

The noise level estimation unit 27 that is an example of a noise information acquisition unit estimates noise level that is level of noise contained in sound acquired by the first sound acquisition unit 21 and the second sound acquisition unit 22. The noise level is an example of noise information. The noise level may be estimated according to any suitable existing method. The noise level may be an average of sound pressure in a non-speech section. The noise level may be calculated using the time-domain sound signal, and the average may be any of an arithmetic average, a geometric average, a harmonic average, and a moving average.

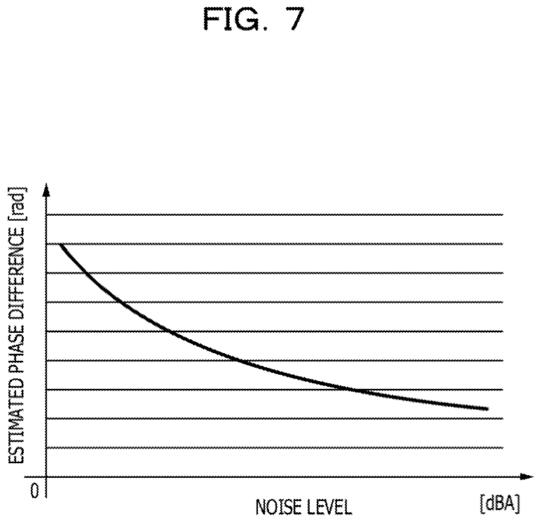

The model correction unit 29 that is an example of a model generation unit and a threshold setting unit corrects the reference model based on the estimated noise level to generate a correction model. As the surrounding noise level becomes larger, as illustrated in FIG. 7, the sound estimated phase difference comes closer to 0 [rad]. When the determination boundary is corrected only based on the inclination of the housing 11 of the speaker direction determination apparatus 10 with respect to the reference position, the determination accuracy of the speaker direction lowers.

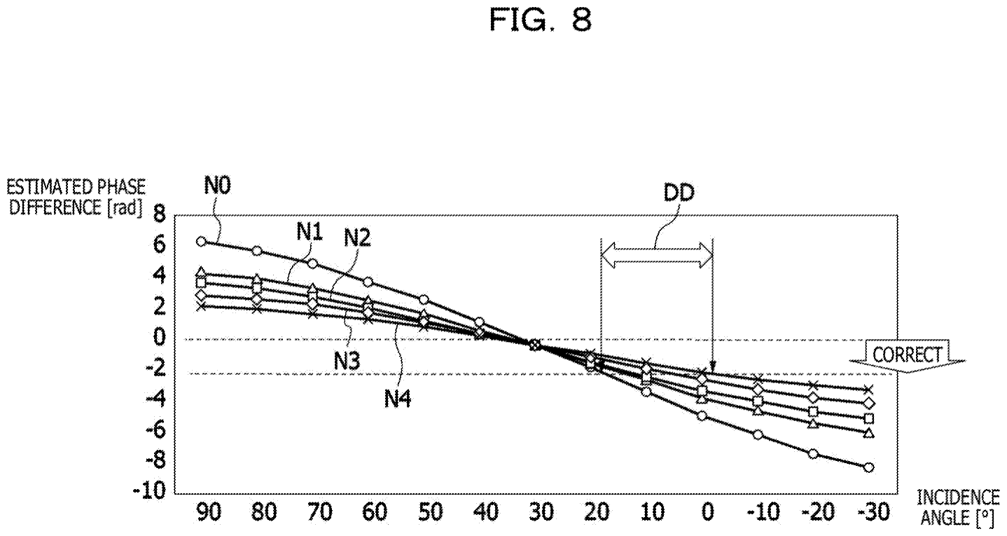

FIG. 8 is a graph illustrating a relation between the estimated phase difference and the sound incidence angle. A vertical axis in FIG. 8 represents the estimated phase difference [rad], and the horizontal axis represents the sound incidence angle [degree]. A line N0 indicates the case of the noise level of 0 [dBA], a line N1 indicates the case of the noise level of 50 [dBA], a line N2 indicates the case of the noise level of 55 [dBA], a line N3 indicates the case of the noise level of 60 [dBA], and a line N4 indicates the case of the noise level of 65 [dBA].

In FIG. 8, there is a difference of about 20 [degrees] between the sound incidence angle with which the phase difference becomes −2 [rad] when the noise level is 0 [dBA] and the sound incidence angle with which the phase difference becomes −2 [rad] when the noise level is 65 [dBA].

When stationary noise exists in surroundings, as expressed as a formula (4), the phase spectra θₜ₁(k) and θₜ₂(k) each includes noise component z_{N}(k).

θₜ₁(k)=arg(z₁(k)+z_{N}(k))

θₜ₂(k)=arg(z₂(k)+z_{N}(k)) (4)

In the phase difference expressed as a formula (5), as expressed as a formula (6), as the noise component z_{N}(k) comes closer to ∞, the phase difference gets closer to 0.

$$\begin{matrix}\begin{matrix}{θ}_{t 1} ( k ) = {θ}_{t 2} ( k ) \\ = arg ( {z}_{1} ( k ) + {z}_{N} ( k ) ) - arg ( {z}_{2} ( k ) + {z}_{N} ( k ) ) \\ = arg ( ( {z}_{1} ( k ) + {z}_{N} ( k ) ) / {z}_{2} ( k ) + {z}_{N} ( k ) )\end{matrix} & ( 5 ) \\ {lim}_{{z}_{N} ( k ) - ∞} arg ( \frac{{z}_{1} ( k ) + {z}_{N} ( k )}{{z}_{2} ( k ) + {z}_{N} ( k )} ) = {lim}_{{z}_{N} ( k ) - ∞} arg ( \frac{\frac{{z}_{1} ( k )}{{z}_{N} ( k )} + 1}{\frac{{z}_{2} ( k )}{{z}_{N} ( k )} + 1} ) & ( 6 )\end{matrix}$$

When the noise level of surrounding stationary noise becomes large, the phase difference of target sound is buried, such that the sound phase difference approaches the phase difference of stationary noise.

The model correction unit 29 adjusts a correction amount of the determination boundary based on the noise level estimated by the noise level estimation unit 27. Describing in detail, the correction amount is adjusted such that the determination boundary comes closer to the uncorrected determination boundary as the noise level increases.

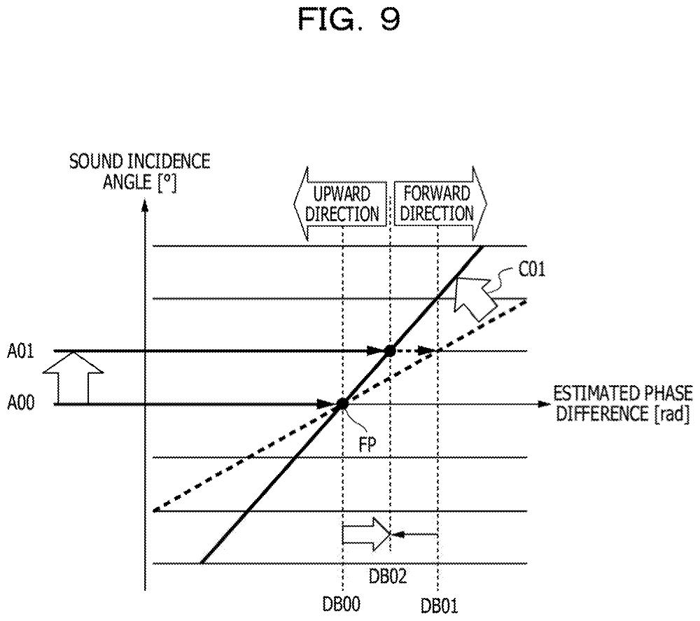

As illustrated in FIG. 6, the determination boundary is corrected from DB00 to DB01 based on the inclination of the housing 11 of the speaker direction determination apparatus 10 with respect to the reference position. As illustrated in FIG. 9, the reference model is rotated as represented by an arrow C01 such that the inclination of the model becomes larger using a fixed point FP as the noise level increases to generate a correction model. The fixed point FP may be empirically determined. As the inclination of the model becomes larger, a determination boundary DB02 that is the estimated phase difference corresponding to the sound incidence angle associated with the inclination with respect to the reference position of the housing 11 comes, in the model, closer from the corrected determination boundary DB01 to the original determination boundary DB00.

A formula (7) illustrates the correction model.

φ=f(α(np)*ap+(1−α(np))*pz) (7)

φ is the sound incidence angle, α( ) is a function for calculating a control parameter that depends on the noise level, np is the noise level, ap is the estimated phase difference, and pz is the estimated phase difference at the fixed point FP.

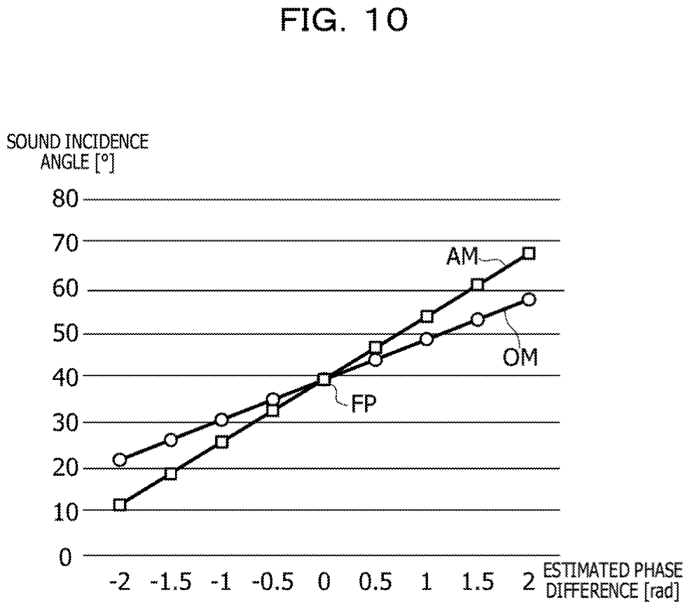

FIG. 10 illustrates an example of a reference model OM. The point FP is a fixed point. A formula (8) illustrates the estimated phase difference pz at the fixed point FP, the function f(ap) indicating the reference model OM, and the control parameter α(np) that depends on the noise level.

pz=0.0

f(ap)=9.0*ap+40.0

α(np)=0.156*np−7.8 (8)

ap is the estimated phase difference, and in more detail, may be an average value of the estimated phase differences from a highest frequency band to a lowest frequency band. np is the noise level, and the estimated phase difference pz at the fixed point FP may be set in advance. The functions f( ) and α( ) are previously derived by statistical regression. The functions f( ) and α( ) may be derived using any of linear function, trigonometric function, and machine learning. Data on the reference model may be previously stored in a table or the like.

When the noise level np is 60 [dBA], the relation: α(60)=0.156*60−7.8=1.56 holds, and a function fd(ap) indicating a correction model AM is expressed as a formula (9).

$$\begin{matrix}fd ( ap ) = 9.0 * a ( np ) * ap + 9.0 * ( 1 - a ( np ) ) * pz + 40.0 \\ = 9.0 * 1.56 * ap + 40.0 \\ = 14.04 * ap + 40.0\end{matrix} \qquad ( 9 )$$

For example, when the correction model AM has a larger inclination than the reference model OM (14.04>9.0) and the estimated phase difference ap is 0, the correction model AM has the same sound incidence angle as the reference model OM (40.0 [degrees]).

When the inclination of the housing 11 of the speaker direction determination apparatus 10 with respect to the reference position is θ [degree], a determination boundary Th(θ) of the reference model OM is expressed as a formula (10).

Th(θ)=f⁻¹(f(Th₀)−θ) (10)

Th₀ is a determination boundary in the case where the housing 11 of the speaker direction determination apparatus 10 is located at the reference position. In the case of Th₀=0.0, Th(θ)=−0.11θ, and when the inclination of the housing 11 of the speaker direction determination apparatus 10 with respect to the reference position is −10 [degree], a relation: Th(−10)=1.1 [rad] holds.

When the inclination of the housing 11 of the speaker direction determination apparatus 10 with respect to the reference position is θ [degree], a determination boundary Thd(θ) of the correction model AM is expressed as a formula (11).

Thd(θ)=fd⁻¹(fd(Thd₀)−θ) (11)

Thd₀ is a determination boundary in the case where the housing 11 of the speaker direction determination apparatus 10 is located at the reference position. In the case of Thd₀=0.0, Thd(θ)=−0.07θ, and when the inclination of the housing 11 of the speaker direction determination apparatus 10 with respect to the reference position is −10 [degree], a relation: Thd(−10)=0.71 [rad] holds. Thus, the determination boundary in the correction model AM shifts from the determination boundary of 1.1 [rad] corrected based on the inclination of the housing 11 with respect to the reference position in the reference model OM toward the determination boundary of 0.0 [rad] before correction based on the inclination of the housing 11.

The direction determination unit 31 that is an example of a determination unit compares the determination boundary set by the mode correction unit 29, for example, the estimated phase difference corresponding to the inclination of the housing 11 with respect to the reference position in the correction model with the phase difference estimated by the phase difference estimation unit 25, thereby determining the speaker direction. The direction of the reference position is not limited to the above-mentioned direction of gravity acceleration, and may be any predetermined direction. The predetermined direction may be a direction along a vertical center line of the housing in the normal position when worn by the user, and previously set by measurement. The predetermined direction may be specified by an angle difference from the direction of gravity acceleration.

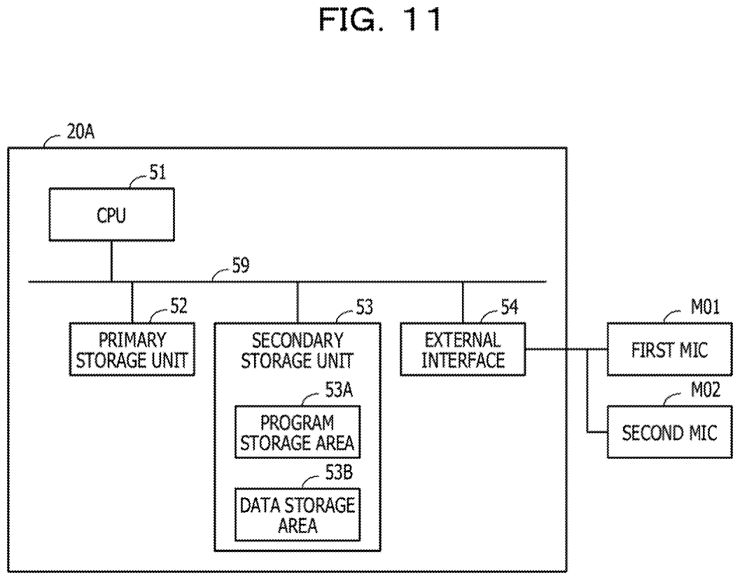

FIG. 11 illustrates a hardware configuration of the speaker direction determination unit 20A. The speaker direction determination unit 20A includes a central processing unit (CPU) 51 that is an example of a processor as hardware, a primary storage unit 52, secondary storage unit 53, and an external interface 54.

The CPU 51, the primary storage unit 52, the secondary storage unit 53, and the external interface 54 are interconnected via a bus 59.

The primary storage unit 52 is a nonvolatile memory such as a random-access memory (RAM).

The secondary storage unit 53 includes a program storage area 53A and a data storage area 53B. As an example, the program storage area 53A stores a program such as a speaker direction determination program that causes the CPU 51 to execute speaker direction determination processing. For example, the data storage area 538 stores a value of the inclination of the housing 11 worn by a particular user with respect to the reference position, data on the reference model, and intermediate data temporarily generated in the speaker direction determination processing.

The CPU 51 reads the speaker direction determination program from the program storage area 53A, and expands the read program in the primary storage unit 52. The CPU 51 loads and executes the speaker direction determination program, thereby functioning as the first sound acquisition unit 21, the second sound acquisition unit 22, the first time-frequency conversion unit 23, the second time-frequency conversion unit 24, the phase difference estimation unit 25, the inclination acquisition unit 26, and the noise level estimation unit 27 in FIG. 3. The CPU 51 also functions as the determination boundary correction unit 28, the model correction unit 29, and the direction determination unit 31.

The program such as the speaker direction determination program may be stored in a non-transitory recording medium such as a digital versatile disc (DVD), read via a recording medium reader, and expanded in the primary storage unit 52.

An external device is coupled to the external interface 54, and the external interface 54 causes the external device to exchange various information with the CPU 51. For example, the external interface 54 is coupled to the first mic M01 and the second mic M02.

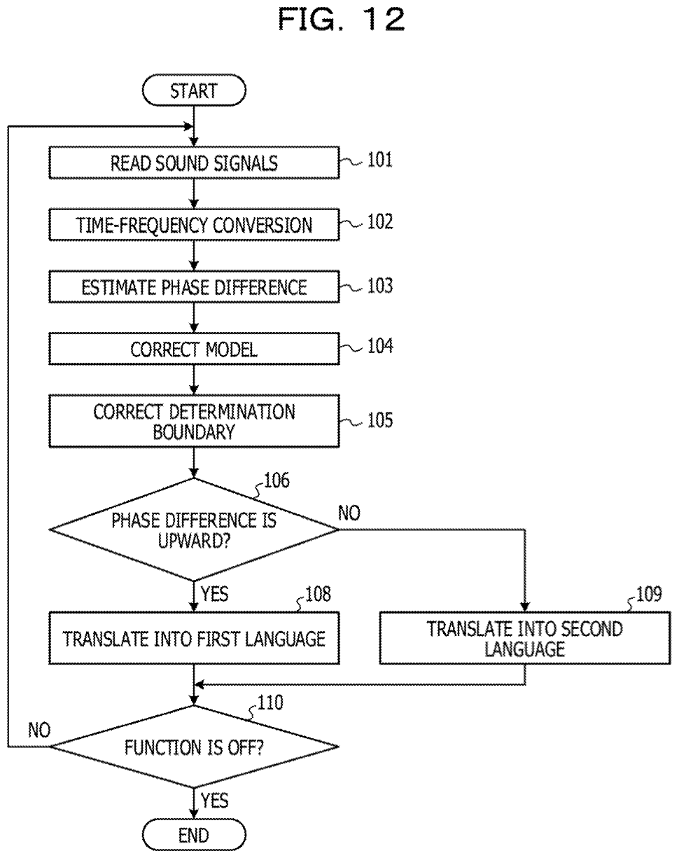

Next, actions of the speaker direction determination apparatus 10 are summarized. The flow of actions of the speaker direction determination apparatus 10 is summarized in FIG. 12. For example, when the user turns on the speaker direction determination apparatus 10, in a step 101, the CPU 51 reads a sound signal for 1 frame. Describing in detail, a time-domain sound signal for 1 frame corresponding to sound acquired from the first mic M01 (hereinafter referred to as first sound signal) and a time-domain sound signal for 1 frame corresponding to sound acquired from the second mic M02 (hereinafter referred to as second sound signal) are read. When a sampling frequency is 16 [kHz], 1 frame may be 32 [ms], for example.

In a step 102, the CPU 51 applies time-frequency conversion to each of the sound signal in the step 101. In a step 103, the CPU 51 estimates a phase difference between the first sound signal and the second sound signal, which are converted into the frequency-domain sound signal. In a step 104, the CPU 51 uses the noise level of at least one of the first sound signal and the second sound signal to correct the reference model, generating the correction model.

In a step 105, the CPU 51 sets a value corrected by applying the inclination of the housing 11 of the speaker direction determination apparatus 10 with respect to the reference position to the correction model generated in the step 104, as the determination boundary. In a step 106, the CPU 51 determines whether or not the estimated phase difference is equal to or smaller than the determination boundary. When the determination in the step 106 is affirmative, for example, the estimated phase difference is equal to or smaller than the determination boundary, it is determined that the speaker is present above, the CPU 51 proceeds to a step 108. In the step 108, the CPU 51 routes the sound signal to processing of translating the second language into the first language, and proceeds to a step 110.

When the determination in the step 106 is negative, for example, the estimated phase difference is larger than the determination boundary, it is determined that the speaker is present ahead, and proceeds to a step 109. In the step 109, the CPU 51 routes the sound signal to processing of translating the first language into the second language, and proceeds to a step 110. The routed sound signal is translated from the second language into the first language by an existing voice translation technique and for example, output as voice from a speaker.

In the step 110, the CPU 51 determines whether or not the user turns off the speaker direction determination function of the speaker direction determination apparatus 10. When the determination in the step 110 is negative, for example, speaker direction determination function is turned on, the CPU 51 returns to the step 101, reads sound signals in a next frame, and continues the speaker direction determination processing. When the determination in the step 110 is affirmative, for example, the speaker direction determination function is turned off, the CPU 51 finishes the speaker direction determination processing.

An object of the present embodiment is to properly determine the speaker direction. When the speaker direction is determined by comparing the phase difference between the frequency-domain sound signals corresponding to sound acquired by the plurality of microphones with the threshold, to properly determine the speaker direction, the threshold may be adjusted based on the inclination of the housing of the speaker direction determination apparatus with respect to the reference position. The inventors deem that the phase difference is affected by noise and reduced in a high-noise environment, possibly failing to properly determine the speaker direction.

In the present embodiment, inclination information indicating the inclination of the housing including the plurality of microphones with respect to the reference position is acquired, and noise information on noise contained in at least one of the plurality of sound signals acquired by the plurality of microphones is acquired. Based on the plurality of sound signals acquired by the plurality of microphones, the physical quantity indicating at least one of the phase difference and the sound pressure difference is acquired. The reference model indicates correspondence between the sound incidence angle onto the plurality of microphones in the case where the housing is located at the reference position, and the physical quantity acquired in the case where the housing is located at the reference position. The physical quantity in the correspondence in the reference model is corrected to correspond to the noise level indicated by the acquired noise information to generate the correction model. In the correction model, the physical quantity corresponding to the sound incidence angle associated with the inclination indicated by the acquired inclination information is set as a threshold. The speaker direction that is the direction in which the speaker making a speech corresponding to the plurality of sound signals acquired by the plurality of microphones is present is determined by comparing the acquired physical quantity with the set threshold.

In the present embodiment, even when the housing of the speaker direction determination apparatus is inclined with respect to the reference position in high-noise environment, the speaker direction may be properly determined.

### Second Embodiment

A second embodiment is different from the first embodiment in that the model is corrected using a signal-to-noise ratio (hereinafter referred to as SNR) in place of the noise level. The SNR is an example of the noise information. Description of the same configuration and actions as those of the first embodiment is omitted.

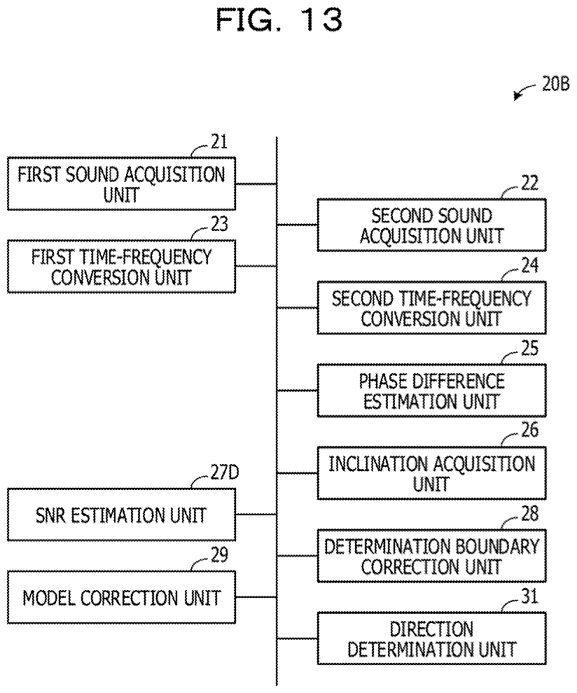

FIG. 13 illustrates a speaker direction determination unit 20B in accordance with the second embodiment. The speaker direction determination unit is different from the speaker direction determination unit 20A in the first embodiment in that an SNR estimation unit 27D is provided in place of the noise level estimation unit 27. SNR is calculated according to a formula (11), for example.

SNR=vp−np (11)

vp is a sound pressure level in a speech section, and np is the noise level.

A formula (12) illustrates the correction model. α2( ) is a control parameter that depends on SNR, and is derived by statistical regression using any of linear function, trigonometric function, machine learning, or the like. α2( ) may be stored in a table or the like in advance.

φ=f(α2(SNR)*ap+(1−α2(SNR))*pz) (12)

In the second embodiment, the correction model is generated such that the determination boundary shifts from the determination boundary corrected based on the inclination of the housing 11 with respect to the reference position toward the uncorrected determination boundary as SNR becomes smaller. This is due to that as SNR decreases, the noise level increases.

In the present embodiment, inclination information indicating the inclination of the housing including the plurality of microphones with respect to the reference position is acquired, and noise information on noise contained in at least one of the plurality of sound signals acquired by the plurality of microphones is acquired. Based on the plurality of sound signals acquired by the plurality of microphones, the physical quantity indicating at least one of the phase difference and the sound pressure difference is acquired. The reference model indicates correspondence between the sound incidence angle onto the plurality of microphones in the case where the housing is located at the reference position, and the physical quantity acquired in the case where the housing is located at the reference position. The physical quantity in the correspondence in the reference model is corrected to correspond to the noise level indicated by the acquired noise information to generate the correction model. In the correction model, the physical quantity corresponding to the sound incidence angle associated with the inclination indicated by the acquired inclination information is set as a threshold. The speaker direction that is the direction in which the speaker making a speech corresponding to the plurality of sound signals acquired by the plurality of microphones is present is determined by comparing the acquired physical quantity with the set threshold.

In the present embodiment, even when the housing of the speaker direction determination apparatus is inclined with respect to the reference position in high-noise environment, the speaker direction may be properly determined.

### Third Embodiment

A third embodiment is different from the first and second embodiments in that the estimated phase difference is corrected instead of generating the correction model to set the corrected determination boundary. The description of the configuration and operation that are substantially the same as those of the first and second embodiments will be omitted.

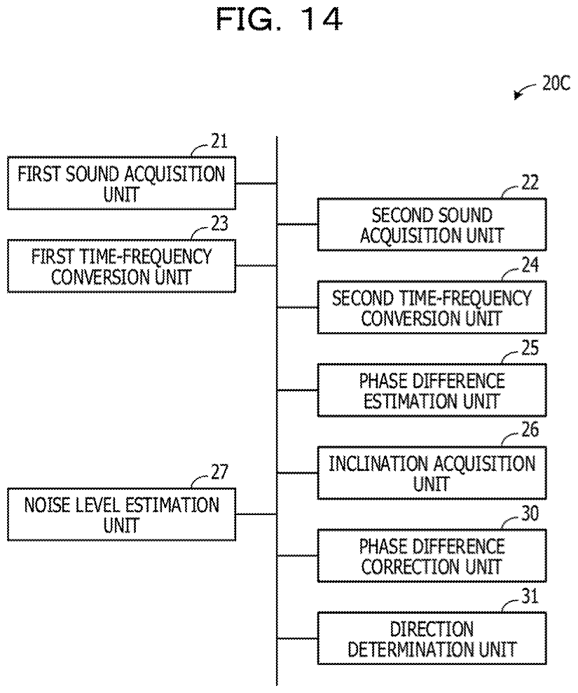

FIG. 14 illustrates a speaker direction determination unit 20C in accordance with the third embodiment. The speaker direction determination unit 20C in FIG. 14 is different from the speaker direction determination units in the first and second embodiments in that a phase difference correction unit 30 is provided in place of the model correction unit 29 and the determination boundary correction unit 28.

The phase difference correction unit 30 is an example of a model generation unit, a threshold setting unit, and a physical quantity generation unit, and as illustrated as a formula (13), calculates a correction phase difference apa.

apa=α(np)*ap+(1−α(np))*pz−Th(θ)+Th₀ (13)

In the present embodiment, the speaker direction is determined by comparing the correction phase difference apa with the determination boundary, for example, the estimated phase difference corresponding to the inclination of the housing 11 of the speaker direction determination apparatus 10 with respect to the reference position in the reference model.

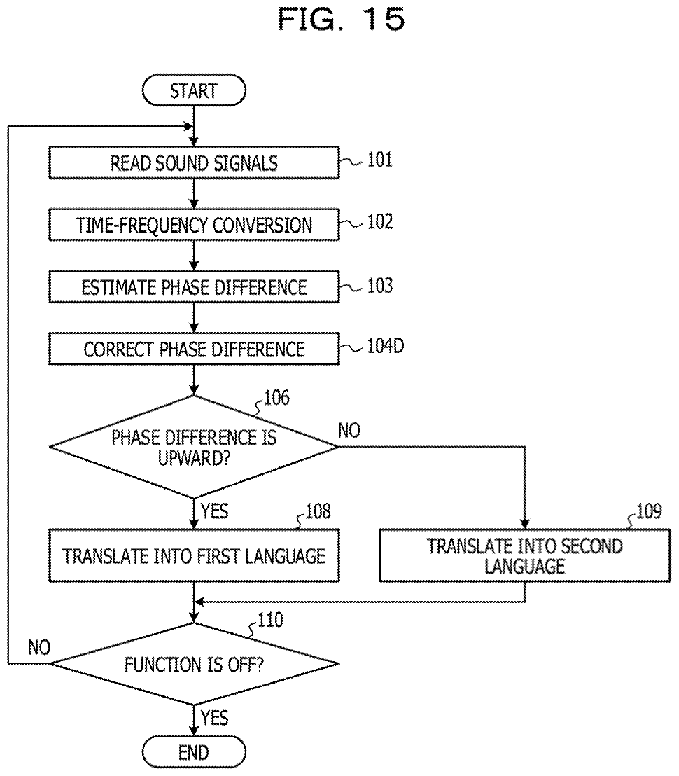

FIG. 15 illustrates a flow of speaker direction determination processing in the third embodiment. The third embodiment in FIG. 15 is different from the first and second embodiments in that phase difference correction in a step 104D is included in place of model correction in the step 104 and determination boundary correction in the step 105 in FIG. 12. In the step 104D, the CPU 51 calculates the estimated phase difference corrected based on the noise level np and the inclination of the housing 11 of the speaker direction determination apparatus 10 with respect to the reference position, for example, according to the formula (13). The estimated phase difference may be corrected using the signal-to-noise ratio in place of the noise level.

In the present embodiment, inclination information indicating the inclination of the housing including the plurality of microphones with respect to the reference position is acquired, and noise information on noise contained in at least one of the plurality of sound signals acquired by the plurality of microphones is acquired. Based on the plurality of sound signals acquired by the plurality of microphones, the physical quantity indicating at least one of the phase difference and the sound pressure difference is acquired. The reference model indicates correspondence between the sound incidence angle onto the plurality of microphones in the case where the housing is located at the reference position, and the physical quantity acquired in the case where the housing is located at the reference position. The physical quantity in the correspondence in the reference model is corrected to correspond to the noise level indicated by the acquired noise information to generate the correction model. The physical quantity corresponding to the sound incidence angle associated with the inclination indicated by the inclination information acquired in the correction model is set as a threshold. The acquired physical quantity is corrected such that a relation between the physical quantity corresponding to the sound incidence angle associated with the inclination indicated by the inclination information acquired in the reference model and a reference threshold becomes equal to a relation between the acquired physical quantity and the set threshold, to generate a correction physical quantity. The speaker direction that is the direction in which the speaker making a speech corresponding to the plurality of sound signals acquired by the plurality of microphones is present is determined by comparing the generated correction physical quantity with the reference threshold.

In the present embodiment, even when the housing of the speaker direction determination apparatus is inclined with respect to the reference position in high-noise environment, the speaker direction may be properly determined.

### Fourth Embodiment

A fourth embodiment is different from the first embodiment in that the speaker direction is determined by using an estimated sound pressure difference instead of using the estimated phase difference to determine the speaker direction. Description of the same configuration and actions as those of the first to third embodiments is omitted.

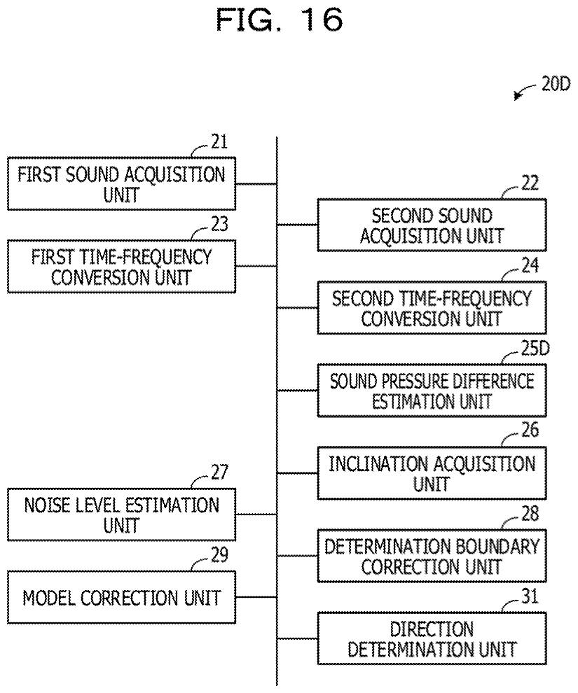

FIG. 16 illustrates a speaker direction determination apparatus 20D in accordance with the fourth embodiment. The speaker direction determination apparatus 20D in FIG. 16 is different from the speaker direction determination apparatus in the first embodiment in that a sound pressure difference estimation unit 25D is provided in place of the phase difference estimation unit 25. In the second and third embodiments, the phase difference estimation unit may be replaced with the sound pressure difference estimation unit. When the fourth embodiment is applied to the third embodiment, the phase difference correction unit is replaced with the sound pressure difference correction unit.

The sound pressure difference estimation unit 25D that is an example of a physical quantity acquisition unit calculates an estimated sound pressure difference dpo(k) in a kth (k=0, 1, . . . , k−1) frequency band as expressed as a formula (14). k may be 256, for example. The estimated sound pressure difference is an example of the physical quantity. The estimated sound pressure difference dpo(k) is, for example, a difference between sound pressure power P₁(k) of the frequency-domain sound signal corresponding to sound acquired by the first mic M01 and sound pressure power P₂(k) of the frequency-domain sound signal corresponding to sound acquired by the second mic M02.

$$\begin{matrix}dpo ( k ) = {P}_{1} ( k ) - {P}_{2} ( k ) \\ = 10 {log}_{10} ( {\vert {z}_{1} ( k ) \vert}^{2} ) - 10 {log}_{10} ( {\vert {z}_{2} ( k ) \vert}^{2} ) \\ = 10 {log}_{10} ( {\vert {z}_{1} ( k ) \vert}^{2} / {\vert {z}_{2} ( k ) \vert}^{2} )\end{matrix} \\ \begin{matrix}{P}_{1} ( k ) = 10 {log}_{10} ( {{Re}_{1} ( k )}^{2} + {{Im}_{1} ( k )}^{2} ) \\ = 10 {log}_{10} ( {\vert {z}_{1} ( k ) \vert}^{2} )\end{matrix} \\ \begin{matrix}{P}_{2} ( k ) = 10 {log}_{10} ( {{Re}_{2} ( k )}^{2} + {{Im}_{2} ( k )}^{2} ) \\ = 10 {log}_{10} ( {\vert {z}_{2} ( k ) \vert}^{2} )\end{matrix} \qquad ( 14 )$$

As expressed as a formula (15), z₁(k) is the sound signal in the kth frequency band, which is converted by the first time-frequency conversion unit 23, expressed as a complex number, Re₁(k) is a real part of the complex number, and Im₁(k) is an imaginary part of the complex number. z₂(k) is the frequency-domain sound signal in the kth frequency band, which is converted by the second time-frequency conversion unit 24, expressed as a complex number, Re₂(k) is a real part of the complex number, and Im₂(k) is an imaginary part of the complex number.

z₁(k)=Re₁(k)+i Im₁(k)

z₂(k)=Re₂(k)+i Im₂(k) (15)

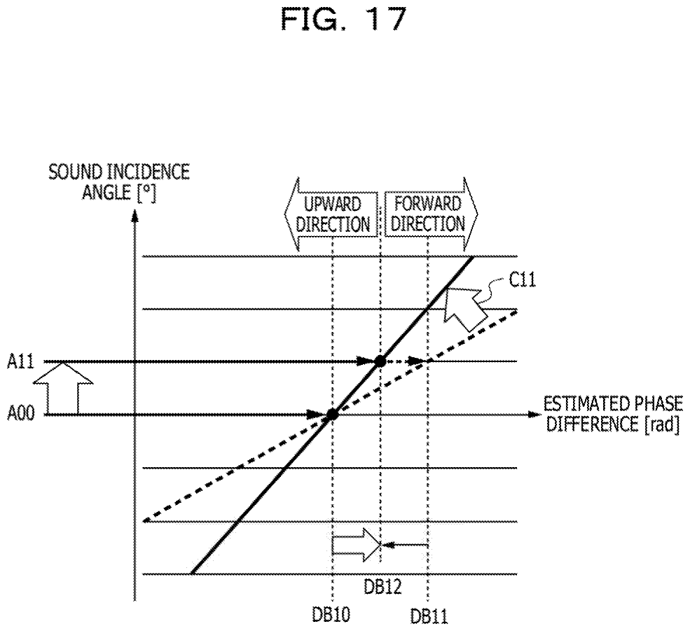

In the fourth embodiment, the estimated phase difference dp(k) in the first to third embodiments is replaced with the estimated sound pressure difference dpo(k). The model indicating the relation between the sound incidence angle and the estimated phase difference in the first to third embodiments is replaced with a model indicating a relation between the sound incidence angle and the estimated sound pressure difference in FIG. 17.

When surrounding stationary noise exists, as expressed as a formula (16), power spectra Pₜ₁(k) and Pₜ₂(k) contain a noise component z_{N}(k).

Pₜ₁(k)=10 log₁₀(|z₁(k)+z_{N}(k)|²)

Pₜ₂(k)=10 log₁₀(|z₂(k)+z_{N}(k)|²) (16)

Thus, as expressed as a formula (17), the estimated sound pressure difference also contains the noise component z_{N}(k).

$$\begin{matrix}{P}_{t 1} ( k ) - {P}_{t 2} ( k ) = 10 {log}_{10} ( {\vert {z}_{1} ( k ) + {z}_{N} ( k ) \vert}^{2} ) - \\ 10 {log}_{10} ( {\vert {z}_{2} ( k ) + {z}_{N} ( k ) \vert}^{2} ) \\ = 10 {log}_{10} ( {\vert {z}_{1} ( k ) + {z}_{N} ( k ) \vert}^{2} / {\vert {z}_{2} ( k ) + {z}_{N} ( k ) \vert}^{2} )\end{matrix} \qquad ( 17 )$$

In the formula (17), as expressed as a formula (18), as the noise component z_{N}(k) comes closer to ∞, the sound pressure difference approaches 0.

$${lim}_{{z}_{N} ( k ) - ∞} 10 {log}_{10} ( {\vert \frac{{z}_{1} ( k ) + {z}_{N} ( k )}{{z}_{2} ( k ) + {z}_{N} ( k )} \vert}^{2} ) = {lim}_{{z}_{N} ( k ) - ∞} 10 {log}_{10} ( {\vert \frac{\frac{{z}_{1} ( k )}{{z}_{N} ( k )} + 1}{\frac{{z}_{2} ( k )}{{z}_{N} ( k )} + 1} \vert}^{2} ) \qquad ( 18 )$$

For example, when surrounding stationary noise is large, the sound pressure difference of the target sound is buried, resulting in that the estimated sound pressure difference of the sound comes close to the sound pressure difference of stationary noise.

A correction model p in the case of the reference model of φ_{D}=f_{D}(apo) is expressed as a formula (19).

φ_{D}=f_{D}(α_{D}(np)*apo+(1−α_{D}(np))*poz) (19)

apo is the estimated sound pressure difference, and poz is the estimated sound pressure difference at the fixed point. The estimated sound pressure difference apo may be an average value of sound pressure differences from the highest frequency band to the lowest frequency band, and the sound pressure difference poz at the fixed point may be 0, for example. f_{D}( ) and α_{D}( ) are previously derived by statistical regression. f_{D}( ) and α_{D}( ) may be derived using any of linear function, trigonometric function, and machine learning.

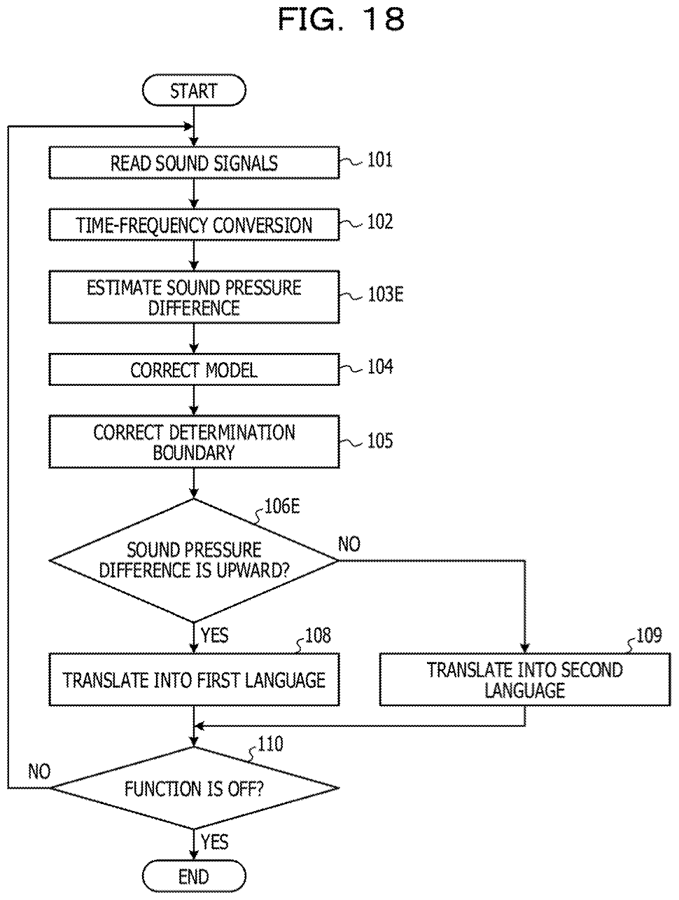

FIG. 18 illustrates an example of a flow of speaker direction determination processing in accordance with the fourth embodiment. This flow is different from the flow of the speaker direction determination processing in the first embodiment in FIG. 12 in that the sound pressure difference is estimated in a step 103E, and the speaker direction is determined using the sound pressure difference in a step 106E.

In the step 103E, the CPU 51 estimates the sound pressure difference, for example, according to the formula (14), and in the step 106E, it is determined whether or not the sound pressure difference is equal to or smaller than the determination boundary. When the determination in the step 106 is affirmative, the CPU 51 proceeds to the step 108, and when the determination in the step 106 is negative, the CPU 51 proceeds to the step 109.

A sound pressure difference estimation unit may be added to the phase difference estimation unit in the first and second embodiments, and a sound pressure difference correction unit may be added to the phase difference correction unit in the third embodiment. In this case, the speaker direction may be determined using both the phase difference and the sound pressure difference.

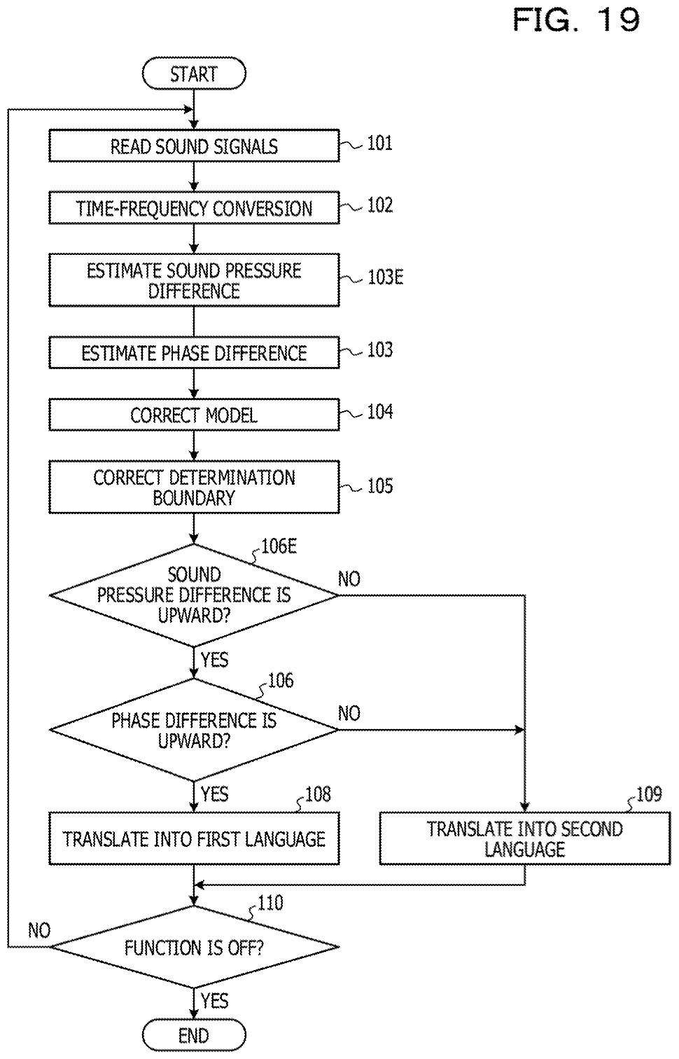

FIG. 19 illustrates an example of a flow of speaker direction determination processing in the case where the speaker direction determination unit in the first and second embodiments includes the sound pressure difference estimation unit in addition to the phase difference estimation unit. In FIG. 19, the sound pressure difference calculation in the step 103E is added to the phase difference calculation in the step 103 in FIG. 12, and the speaker direction determination based on the sound pressure difference in the step 106E is added to the speaker direction determination based on the phase difference in the step 106.

The CPU 51 estimates the sound pressure difference in the step 103E, and estimates the phase difference in the step 103. In the step 106E, the CPU 51 determines whether or not the sound pressure difference estimated in the step 103E is equal to or smaller than the determination boundary of the sound pressure difference found by applying the inclination of the housing 11 of the speaker direction determination apparatus 10 to the correction model generated in the step 104, which indicates the relation between the sound incidence angle and the estimated sound pressure difference.

When the determination in the step 106E is affirmative, the CPU 51 proceeds to the step 106. In the step 106, the CPU 51 determines whether or not the phase difference estimated in the step 103 is equal to or smaller than the determination boundary of the phase difference found by applying the inclination of the housing 11 of the speaker direction determination apparatus 10 to the correction model generated in the step 104, which indicates the relation between the sound incidence angle and the estimated phase difference.

When the determination in the step 106 is affirmative, for example, the speaker direction is determined to be the upward direction, the CPU 51 proceeds to the step 110. When the determination in the step 106E is negative or the determination in the step 106 is negative, for example, the speaker direction is determined to be the forward direction, the CPU 51 proceeds to the step 109.

By combining the estimated phase difference with the estimated sound pressure difference, even when either of them is not property estimated, the speaker direction may be property determined. The processing in FIG. 19 is an example, and various combination of the estimated phase difference determination and the estimated sound pressure difference determination may be made. For example, the determination in the step 106 may be made prior to the determination in the step 106E.

In the present embodiment, inclination information indicating the inclination of the housing including the plurality of microphones with respect to the reference position is acquired, and noise information on noise contained in at least one of the plurality of sound signals acquired by the plurality of microphones is acquired. Based on the plurality of sound signals acquired by the plurality of microphones, the physical quantity indicating at least one of the phase difference and the sound pressure difference is acquired. The reference model indicates correspondence between the sound incidence angle onto the plurality of microphones in the case where the housing is located at the reference position, and the physical quantity acquired in the case where the housing is located at the reference position. The physical quantity in the correspondence in the reference model is corrected to correspond to the noise level indicated by the acquired noise information to generate the correction model. In the correction model, the physical quantity corresponding to the sound incidence angle associated with the inclination indicated by the acquired inclination information is set as a threshold. The speaker direction that is the direction in which the speaker making a speech corresponding to the plurality of sound signals acquired by the plurality of microphones is present is determined by comparing the acquired physical quantity with the set threshold.

In the present embodiment, even when the housing of the speaker direction determination apparatus is inclined with respect to the reference position in high-noise environment, the speaker direction may be properly determined.

The number of the microphones are two in the above-mentioned embodiments, but is not limited to two in the present embodiment, and may be three or more. For example, the speaker direction determination apparatus may be spherical, and the microphones may be disposed on the spherical surface at regular intervals. The determination result of the speaker direction is used for translation in the above-mentioned embodiments, but the present embodiment is not limited to this. For example, in generating a minute book, the minute book may be generated by determining the speaker based on the determination result of the speaker direction.

The flowcharts in FIGS. 12, 15, 18, and 19 are examples, and the order of the processing may be appropriately changed.

### Comparative Example

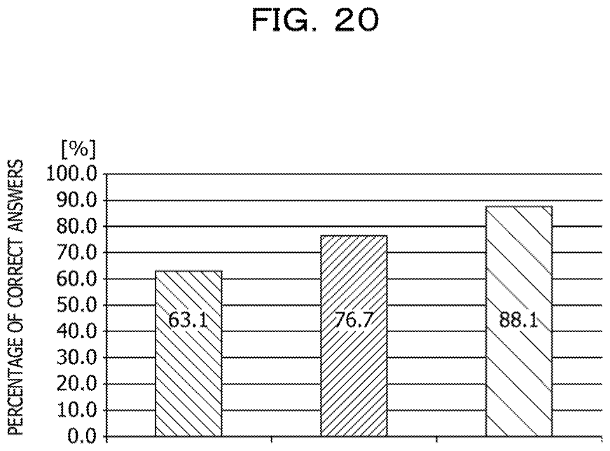

FIG. 20 illustrates a percentage of correct answers of the speaker direction determination processing in each of the case where the determination boundary is not changed, and where the determination boundary is changed based on the inclination of the housing of the speaker direction determination apparatus with respect to the reference position. FIG. 20 illustrates a percentage of correct answers of the speaker direction determination processing in the case where the determination boundary is changed based on the inclination of the housing of the speaker direction determination apparatus with respect to the reference position and the noise information. In this example, the stationary noise is 50 [dBA] and 60 [dBA], and the inclination of the speaker direction determination apparatus with respect to the reference position is 40 [degree].

In the case where the determination boundary is not changed, as represented at the left end in FIG. 20, the percentage of correct answers of the speaker direction determination is 63.1 [%]. In the case where the determination boundary is changed based on the inclination of the housing of the speaker direction determination apparatus with respect to the reference position, as represented at the center in FIG. 20, the percentage of correct answers of the speaker direction determination is 76.6 [%]. In the case where the determination boundary is changed based on the inclination of the housing of the speaker direction determination apparatus with respect to the reference position and the noise information, as represented at the right end in FIG. 20, the percentage of correct answers of the speaker direction determination is 88.1 [%] and is higher than the percentage of correct answers in the case where the determination boundary is not changed by 25%.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
acquiring inclination information indicating an inclination of a housing including a plurality of microphones with respect to a predetermined direction of a reference position;
acquiring noise information on noise contained in at least one of a plurality of sound signals acquired by the plurality of microphones;
acquiring a physical quantity indicating at least one of a phase difference and a sound pressure difference based on the plurality of sound signals acquired by the plurality of microphones;
generating a correction model corrected such that the physical quantity in a correspondence in a reference model indicating the correspondence between a sound incidence angle onto the plurality of microphones in the case where the housing is located at the reference position and the physical quantity acquired in the case where the housing is located at the reference position corresponds to noise level indicated by the acquired noise information;
setting the physical quantity corresponding to the sound incidence angle associated with the inclination indicated by the acquired inclination information in the correction model as a threshold; and
comparing the acquired physical quantity with the set threshold to determine a speaker direction that is a direction in which a speaker making a speech corresponding to the plurality of sound signals acquired by the plurality of microphones is present.

2. A non-transitory computer-readable storage medium storing a program that causes a computer to execute a process, the process comprising:
acquiring inclination information indicating an inclination of a housing including a plurality of microphones with respect to a predetermined direction of a reference position;
acquiring noise information on noise contained in at least one of a plurality of sound signals acquired by the plurality of microphones;
acquiring a physical quantity indicating at least one of a phase difference and a sound pressure difference based on the plurality of sound signals acquired by the plurality of microphones;
generating a correction model corrected such that the physical quantity in a correspondence in a reference model indicating the correspondence between a sound incidence angle onto the plurality of microphones in the case where the housing is located at the reference position and the physical quantity acquired in the case where the housing is located at the reference position corresponds to noise level indicated by the acquired noise information;
setting the physical quantity corresponding to the sound incidence angle associated with the inclination indicated by the acquired inclination information in the correction model as a threshold;
correcting the acquired physical quantity such that a relation between the physical quantity corresponding to the sound incidence angle associated with the inclination indicated by the inclination information acquired in the reference model and a reference threshold becomes equal to a relation between the acquired physical quantity and the set threshold, to generate a correction physical quantity; and
comparing the generated correction physical quantity with the reference threshold to determine a speaker direction that is a direction in which a speaker making a speech corresponding to the plurality of sound signals acquired by the plurality of microphones is present.

3. The storage medium according to claim 2, wherein
the reference model is a straight line on which the sound incidence angle increases in proportion to the physical quantity, and
the correction model is generated by increasing an inclination of the straight line as noise level indicated by the acquired noise information becomes larger using a predetermined point on the straight line as a fixed point.

4. The storage medium according to claim 2, wherein
the noise information is noise level or a signal-to-noise ratio.

5. A speaker direction determination method executed by a computer, the speaker direction determination method comprising:
acquiring inclination information indicating an inclination of a housing including a plurality of microphones with respect to a predetermined direction of a reference position;
acquiring noise information on noise contained in at least one of a plurality of sound signals acquired by the plurality of microphones;
acquiring a physical quantity indicating at least one of a phase difference and a sound pressure difference based on the plurality of sound signals acquired by the plurality of microphones;
generating a correction model corrected such that the physical quantity in a correspondence in a reference model indicating the correspondence between a sound incidence angle onto the plurality of microphones in the case where the housing is located at the reference position and the physical quantity acquired in the case where the housing is located at the reference position corresponds to noise level indicated by the acquired noise information;
setting the physical quantity corresponding to the sound incidence angle associated with the inclination indicated by the acquired inclination information in the correction model as a threshold; and
comparing the acquired physical quantity with the set threshold to determine a speaker direction that is a direction in which a speaker making a speech corresponding to the plurality of sound signals acquired by the plurality of microphones is present.

6. A speaker direction determination method executed by a computer, the speaker direction determination method comprising:
acquiring inclination information indicating an inclination of a housing including a plurality of microphones with respect to a predetermined direction of a reference position;
acquiring noise information on noise contained in at least one of a plurality of sound signals acquired by the plurality of microphones;
acquiring a physical quantity indicating at least one of a phase difference and a sound pressure difference based on the plurality of sound signals acquired by the plurality of microphones;
generating a correction model corrected such that the physical quantity in a correspondence in a reference model indicating the correspondence between a sound incidence angle onto the plurality of microphones in the case where the housing is located at the reference position and the physical quantity acquired in the case where the housing is located at the reference position corresponds to noise level indicated by the acquired noise information;
setting the physical quantity corresponding to the sound incidence angle associated with the inclination indicated by the acquired inclination information in the correction model as a threshold;
correcting the acquired physical quantity such that a relation between the physical quantity corresponding to the sound incidence angle associated with the inclination indicated by the inclination information acquired in the reference model and a reference threshold becomes equal to a relation between the acquired physical quantity and the set threshold, to generate a correction physical quantity; and
comparing the generated correction physical quantity with the reference threshold to determine a speaker direction that is a direction in which a speaker making a speech corresponding to the plurality of sound signals acquired by the plurality of microphones is present.

7. A speaker direction determination apparatus comprising:
a memory; and
a processor coupled to the memory and the processor configured to:
acquire inclination information indicating an inclination of a housing including a plurality of microphones with respect to a predetermined direction of a reference position,
acquire noise information on noise contained in at least one of a plurality of sound signals acquired by the plurality of microphones,
acquire a physical quantity indicating at least one of a phase difference and a sound pressure difference based on the plurality of sound signals acquired by the plurality of microphones,
generate a correction model corrected such that the physical quantity in a correspondence in a reference model indicating the correspondence between a sound incidence angle onto the plurality of microphones in the case where the housing is located at the reference position and the physical quantity acquired in the case where the housing is located at the reference position corresponds to noise level indicated by the acquired noise information,
set the physical quantity corresponding to the sound incidence angle associated with the inclination indicated by the acquired inclination information in the correction model as a threshold, and
compare the acquired physical quantity with the set threshold to determine a speaker direction that is a direction in which a speaker making a speech corresponding to the plurality of sound signals acquired by the plurality of microphones is present.

8. A speaker direction determination apparatus comprising:
a memory; and
a processor coupled to the memory and the processor configured to:
acquire inclination information indicating an inclination of a housing including a plurality of microphones with respect to a predetermined direction of a reference position,
acquire noise information on noise contained in at least one of a plurality of sound signals acquired by the plurality of microphones,
acquire a physical quantity indicating at least one of a phase difference and a sound pressure difference based on the plurality of sound signals acquired by the plurality of microphones,
generate a correction model corrected such that the physical quantity in a correspondence in a reference model indicating the correspondence between a sound incidence angle onto the plurality of microphones in the case where the housing is located at the reference position and the physical quantity acquired in the case where the housing is located at the reference position corresponds to noise level indicated by the acquired noise information,
set the physical quantity corresponding to the sound incidence angle associated with the inclination indicated by the acquired inclination information in the correction model as a threshold,
correct the acquired physical quantity such that a relation between the physical quantity corresponding to the sound incidence angle associated with the inclination indicated by the inclination information acquired in the reference model and a reference threshold becomes equal to a relation between the acquired physical quantity and the set threshold, to generate a correction physical quantity, and
compare the generated correction physical quantity with the reference threshold to determine a speaker direction that is a direction in which a speaker making a speech corresponding to the plurality of sound signals acquired by the plurality of microphones is present.
